(19) United States
(12) Patent Application Publication
(10) Pub. No.: US 2012/0046813 A1
(43) Pub. Date: Feb. 23, 2012

(54) Method and system for operating an electrical machine, controlled by an inverter, in a motor vehicle in a fault situation

(76) Inventors: Roland Schleser, Saarbruecken (DE); Daniel Kanth, Ludwigsburg (DE); Holger Niemann, Shanghai (CN); Andreas Heyl, Ludwigsburg (DE)

(21) Appl. No.: 13/136,240

(22) Filed: Jul. 26, 2011

(30) Foreign Application Priority Data
Aug. 11, 2010 (DE) 10 2010 039 190.5

(51) Int. Cl. B60W 20/00; B60W 10/08; B60W 10/10; B60W 10/06

(52) U.S. Cl. 701/22; 903/903

(57) ABSTRACT

An electrical machine in a motor vehicle is controlled by an inverter, which motor vehicle has an automatically or manually actuatable transmission. The electrical machine generates, in generator mode, electrical energy that is stored in an energy reservoir. In a fault situation, at least one variable characterizing the charge state of the energy reservoir is detected and compared with a predefined lower threshold value, and upon a shortfall below the lower threshold value, the electrical machine is switched into a freewheeling mode by opening the inverter's switching elements. For an automatic transmission, a higher transmission ratio than a present transmission ratio is additionally established; for a manual transmission, the driver is notified by a message that a lower gear needs to be engaged.

### BACKGROUND OF THE INVENTION

1. Field of the Invention

The invention relates to methods and systems for operating an electrical machine, controlled by an inverter, in a motor vehicle in a fault situation.

2. Description of the Related Art

Electrical machines having inverters are used, for example, in hybrid vehicles, where they are operated selectably in motor mode or generator mode. In motor mode, the electrical machine generates an additional drive torque that assists an internal combustion engine, for example in an acceleration phase; in generator mode it generates electrical energy that is stored in an energy reservoir, for example a battery or a supercap.

The operating mode and power level of the electrical machine are set by way of the inverter.

Because comparatively high currents and voltages must be made available in hybrid vehicles in order to allow the electrical machine to be used as a motor to drive the motor vehicle, operating parameters such as, for example, the phase currents of the electrical machine or the voltages at the pulse width modulated inverter are constantly monitored in order to protect the electrical network and the components connected to the electrical network.

Upon detection of a malfunction, for example a phase overcurrent or an overvoltage, the pulse width modulated inverter is switched into a safe state in order to prevent possible damage to electrical components. Essentially two different switch-off methods are known from the existing art. In a first method, all the switches of the pulse width modulated inverter that are connected to a low potential (low-side switches) are closed, and all the switches of the pulse width modulated inverter that are connected to a high potential (high-side switches) are opened, or vice versa. This operating approach is also referred to as “short circuit mode.” In another switch-off method, all the switches of the pulse width modulated inverter are opened. This is also referred to as “disconnect mode.”

A method known from published German patent application document DE 10 2006 003 254 A1 for switching off an electrical machine having a pulse width modulated inverter in the event of a malfunction provides for minimizing undesired side effect when switching off the electrical machine, and maximizing correct machine operation, by switching the electrical machine firstly into a disconnect mode in which all the switches of the pulse width modulated inverter are opened, and then into a short circuit mode in which the switches connected to the high potential are open, and the switches connected to the low potential are closed.

Published international patent application document WO 2008/135327 A1 discloses a method for fault handling in electrical machines of a hybrid drive system, in which firstly a determination is made as to whether at least one operating parameter of the electrical machine is beyond an associated operating parameter limit value. If it is determined in this context that at least one operating parameter is beyond the associated limit value, a power supply terminal of the electrical machine is disconnected for a time interval associated with the operating parameter, and the power supply terminal is short-circuited to ground after the time interval has elapsed.

Published international patent application document WO 2009/083342 A1 discloses a method for operating an electrical network, in particular of a hybrid motor vehicle, the network having at least one electrical load, at least one electrical machine, and at least one inverter applying control to the electrical machine. When a malfunction is sensed, the electrical reservoir is electrically detached from the network and, when a predefinable network voltage limit is then exceeded, the inverter is switched into a short circuit mode. Provision is made in this context that power semiconductors of the inverter are switched in such a way that a voltage is induced by the driven electrical machine and is made available via freewheeling diodes to the electrical network, and the induced voltage is used to operate the electrical machine in generator fashion so that a predefinable network voltage is established by the electrical machine.

### BRIEF SUMMARY OF THE INVENTION

The present invention provides a method for operating an electrical machine, controlled by an inverter, in a motor vehicle having an automatically actuatable transmission, the electrical machine generating, in generator mode, electrical energy that is stored in an energy reservoir. According to the present invention, in a fault situation at least one variable characterizing the charge state of the energy reservoir, for example a battery voltage or battery current, is sensed and is compared with a predefined lower threshold value. Upon a shortfall below the lower threshold value, the electrical machine is switched into a freewheeling mode by opening all the controllable switching elements of the inverter, and a higher transmission ratio as compared with a present transmission ratio is established in the automatically actuatable transmission.

The present invention also makes available a method for operating an electrical machine, controlled by an inverter, in a motor vehicle having a manually actuatable transmission, the electrical machine generating, in generator mode, electrical energy that is stored in an energy reservoir. According to the present invention, in a fault situation at least one variable characterizing the charge state of the energy reservoir is sensed and is compared with a predefined lower threshold value. Upon a shortfall below the lower threshold value, the electrical machine is switched into a freewheeling mode by opening all the controllable switching elements of the inverter, and a message is outputted to the driver notifying him or her of the need to engage a lower gear.

The present invention furthermore makes available a system for operating an electrical machine, controlled by an inverter, in a motor vehicle having an automatically actuatable transmission, the electrical machine generating, in generator mode, electrical energy that is stored in an energy reservoir. The system encompasses a fault detection device that detects a malfunction and thus a fault situation; a charge state detection device that senses at least one variable characterizing the charge state of the energy reservoir and compares it with a predefined lower threshold value; an inverter controller that, in the event of detection of a fault situation and a shortfall below the lower threshold value, opens all the controllable switching elements of the inverter and thereby switches the electrical machine into a freewheeling mode; and a transmission controller that, in the event of detection of a fault situation and a shortfall below the lower threshold value, controls the automatically actuatable transmission in such a way that a higher transmission ratio as compared with a present transmission ratio is established.

Lastly, the present invention makes available a system for operating an electrical machine, controlled by an inverter, in a motor vehicle having a manually actuatable transmission, the electrical machine generating, in generator mode, electrical energy that is stored in an energy reservoir. The system encompasses a fault detection device that detects a fault situation; a charge state detection device that senses at least one variable characterizing the charge state of the energy reservoir and compares it with a predefined lower threshold value; an inverter controller that, in the event of detection of a fault situation and a shortfall below the lower threshold value, opens all the controllable switching elements of the inverter and thereby switches the electrical machine into a freewheeling mode; and an output unit on which, in the event of detection of a fault situation and a shortfall below the lower threshold value, a message is outputted to the driver notifying him or her of the need to engage a lower gear.

In motor vehicles having at least partly electrified drive trains, a number of functions—for example, brake booster, power steering, lights, or engine controllers—are now made available only electrically, i.e. with the aid of an electrical energy stored in an energy reservoir, for example a high-voltage or low-voltage battery. If a switchover is then effected directly into a short circuit mode upon occurrence of a fault situation, which is expressed e.g. by a phase overcurrent or an overvoltage and which has as a consequence, in particular, that regulated torque can no longer be provided to the electrical machine, the energy reservoir is thus no longer charged by the electrical machine. The result of this in turn, however, is that the remaining range of the motor vehicle is critically and considerably limited by the power consumption of the aforementioned electrical loads. In the worst case the result can be that, in particular in sparsely settled areas or if the charge state of the energy reservoir is low at the time the fault occurs, it is no longer possible to reach a service facility. If, on the other hand, as provided according to the present invention, a switchover into a freewheeling mode is effected in a fault situation, this offers the possibility (in contrast to short circuit mode) of continuing to charge the energy reservoir by way of generator operation of the electrical machine even in a fault situation. The freewheeling diodes of the inverter are used in this context to transfer the charging current. Because of the freewheeling mode, however, the inverter can no longer provide regulated torque to the electrical machine. The invention is thus based on the fundamental idea of controlling the charging power level of the electrical machine that is made available in freewheeling mode by exerting a targeted influence on the rotation speed of the electrical machine. Upon a shortfall below a predefinable threshold value for the charge state of the energy reservoir, the rotation speed of the electrical machine is accordingly actively increased so as thereby to achieve enhanced charging of the energy reservoir. In the case of a motor vehicle having an automatic transmission, the rotation speed increase can be realized directly by automatically downshifting. If, on the other hand, the motor vehicle is equipped only with a manual transmission, a downshift can be effected only with driver involvement. The driver is therefore in this case actively prompted, by output of a corresponding message, to downshift, i.e. to shift into a lower gear. The lower threshold value is usefully defined in such a way that the corresponding charge state of the energy reservoir is sufficient to supply sufficient electrical energy to all the electrical loads necessary for operation. Electrical loads that are not necessary for operation can be switched off in a fault situation.

Minimum charging of the energy reservoir is thus always ensured even in a fault situation; this considerably improves the availability of the motor vehicle, thus avoiding immobilization of the motor vehicle on the open road.

In order to reliably avoid overcharging of the energy reservoir, according to an embodiment of the invention the variable characterizing the charge state of the energy reservoir is also compared with a predefined upper threshold value. Upon exceedance of the upper threshold value, a variety of safety measures can be taken. For example, the electrical machine can be switched into short circuit mode by opening all the controllable switching elements of the inverter that are connected to a high potential and closing all the controllable switching elements of the inverter that are connected to a low potential, or by closing all the controllable switching elements of the inverter that are connected to the high potential and opening all the controllable switching elements of the inverter that are connected to the low potential, which prevents further charging of the energy reservoir. If the motor vehicle is equipped with an automatically actuatable transmission, as an alternative to this a lower transmission ratio as compared with a present transmission ratio can also be automatically established, resulting in a decrease in the charging power level. Establishing a lower transmission ratio is useful especially when a short circuit mode is no longer possible because of a malfunction in a controllable switching element of the inverter or of the associated control unit. If the motor vehicle is equipped only with a manually actuatable transmission, upon exceedance of the upper threshold value a message can be outputted to the driver notifying him or her of the need to engage a higher gear.

In certain operating situations, for example traveling around a curve, the torques associated with an elevated charging power level might, however, result in a destabilization of the drive train of the vehicle. In order to reliably avoid this, the above-described safety measures (short circuit mode, automatic upshift or prompt to upshift) can also be instituted when a destabilization of the drive train may be expected based on a present driving situation and on the torques associated with the present charging power level.

### BRIEF DESCRIPTION OF THE DRAWINGS

FIG. 1 schematically depicts a three-phase electrical machine controlled by an inverter.

FIG. 2 schematically depicts the system according to the present invention for a hybrid vehicle having an automatically actuatable transmission.

FIG. 3 schematically depicts the system according to the present invention for a hybrid vehicle having a manually actuatable transmission.

### DETAILED DESCRIPTION OF THE INVENTION

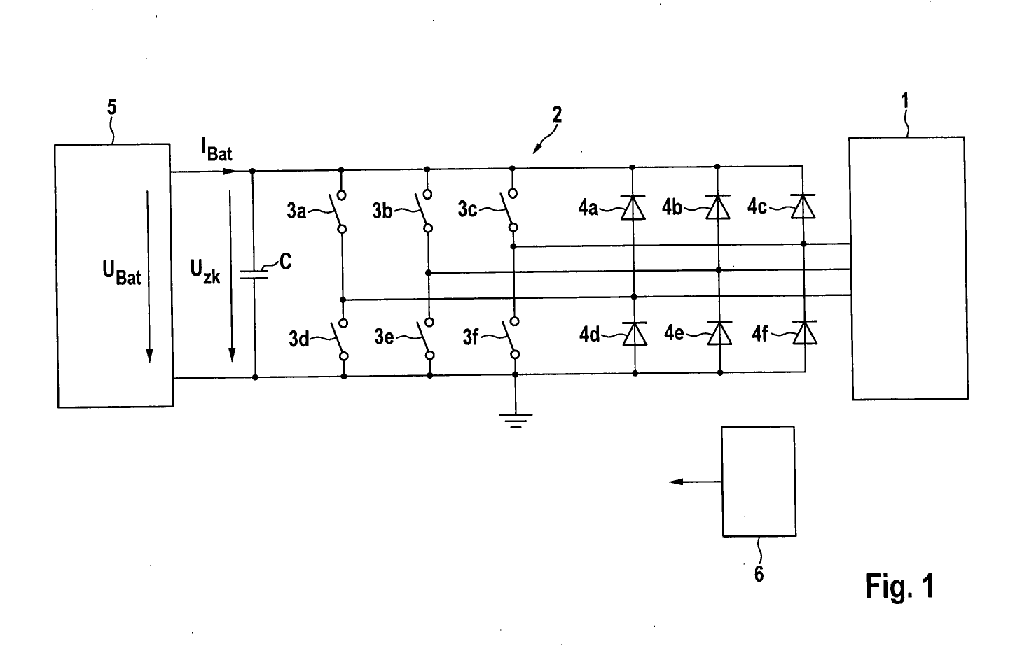

FIG. 1 schematically depicts an electrical machine 1 having connected thereto an inverter in the form of a pulse width modulated inverter 2. Pulse width modulated inverter 2 encompasses multiple power components (often also referred to as “power semiconductors”) in the form of controllable switching elements 3a to 3f that are connected to individual phases U, V, W of electrical machine 1 and that switch phases U, V, W either to a high supply potential (battery voltage UBat) or to a low reference potential (ground). Switching elements 3a to 3c connected to the high supply potential UBat are also referred to as “high-side” switches, and switching elements 3d to 3f connected to ground as “low-side” switches. Pulse width modulated inverter 2 also encompasses further power components in the form of freewheeling diodes 4a to 4f that, in the exemplifying embodiment depicted, are disposed in the form of a six-pulse rectifier bridge circuit. Each diode 4a to 4f is disposed in parallel with one of switching elements 3a to 3f. The switching elements can be embodied, for example, as insulated gate bipolar transistors (IGBTs) or as metal oxide semiconductors field effect transistors (MOSFETs).

Pulse width modulated inverter 2 determines the power level and operating mode of electrical machine 1, and is controlled correspondingly by an inverter controller 6. Electrical machine 1 can thus be operated selectably in motor mode or generator mode. In motor mode it generates an additional drive torque that assists an internal combustion engine (not depicted), for example in an acceleration phase. In generator mode, on the other hand, mechanical energy is converted into electrical energy and stored in an energy reservoir 5 (here a battery). Energy reservoir 5 is connected to an energy supply network (not depicted) in a motor vehicle; the energy reservoir can be embodied as a high-voltage battery, and the energy supply network, for example, as a high-voltage traction network in a hybrid vehicle.

Disposed in parallel with pulse width modulated inverter 2 is a so-called link circuit capacitor C, which serves substantially to stabilize battery voltage U [symbol] Bat and at which a link circuit voltage U [symbol] zk is present.

Electrical machine 1 is embodied with three phases in the exemplifying embodiment depicted, but can also have fewer or more than three phases.

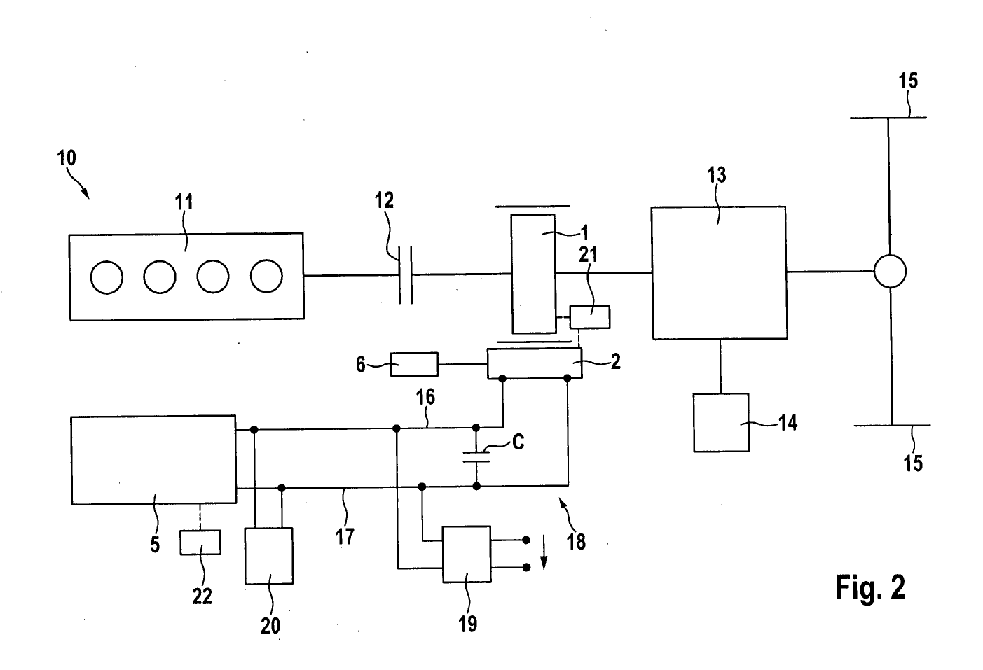

FIG. 2 schematically shows the incorporation of an electrical machine 1, controlled by inverter 2, into a drivetrain 10 of a hybrid vehicle (not depicted further). Drivetrain 10 has an internal combustion engine 11 that can be brought into mechanical effective connection with electrical machine 1 by way of a clutch 12. Both internal combustion engine 11 and electrical machine 1 are, in this context, available as drive units for the hybrid vehicle. Drivetrain 10 furthermore encompasses an automatically actuatable transmission 13, in mechanically effective connection with electrical machine 1, that is controlled by a transmission controller 14 and conveys to drive wheels 15 of the motor vehicle the torque generated by the drive units. In accordance with FIG. 1, electrical machine 1 has associated with it pulse width modulated inverter 2, with which control is applied to electrical machine 1 and which is itself controlled by inverter controller 6. Pulse width modulated inverter 2 is connected via electrical connections 16 and 17 to electrical energy reservoir 5, in particular in the form of a high-voltage battery. Additionally connected to this, by way of inverter 2, energy reservoir 5, and link circuit 18 formed by electrical connections 16 and 17, are a DC/DC converter 19 and at least one high-voltage load 20. By analogy with FIG. 1, link circuit capacitor C is connected in parallel with pulse width modulated inverter 2 in order to stabilize the voltage of energy reservoir 5.

In order to protect the electrical network and the components connected to the electrical network, provision is made that a fault situation in the electrical network is detected with the aid of a fault detection device 21. Fault detection device 21 can be realized, for example, by way of at least one sensor unit including a pertinent evaluation unit, which monitors pulse width modulated inverter 2 and/or electrical machine 1 for overcurrents and/or overvoltages. In addition, with the aid of a charge state detection device 22, at least one variable characterizing the charge state of the energy reservoir, for example a battery current or battery voltage, is sensed and is compared with a predefinable lower threshold value. In the event of detection of a fault situation and a shortfall below the lower threshold value, inverter controller 6, which applies control to controllable switching elements 3a to 3f (see FIG. 1) of pulse width modulated inverter 2, opens all the controllable switching elements 3a to 3f of pulse width modulated inverter 2 and thereby switches electrical machine 1 into a freewheeling mode. In addition, in the event of detection of a fault situation and a shortfall below the lower threshold value, transmission controller 14 controls automatically actuatable transmission 13 in such a way that a higher transmission ratio as compared with a present transmission ratio is established. The rotation speed of electrical machine 1, operated in generator fashion, is thereby increased, and the charging power level for energy reservoir 5 thereby raised. A decrease in the charge of energy reservoir 5 below the predefinable threshold value can thereby be reliably avoided, thus ensuring enhanced availability of the motor vehicle. Information transfer among the individual detection and control components can occur either directly or indirectly via a higher-order control unit, which can also be integrated into one of the existing control units. Corresponding lead connections are, however, not depicted for reasons of clarity.

In order to reliably avoid overcharging of energy reservoir 5, the variable characterizing the charge state of energy reservoir 5 can additionally be compared with a predefinable upper threshold value. Upon exceedance of the upper threshold value, electrical machine 1 can be switched into the short circuit mode by opening all high-side switches 3a to 3c of pulse width modulated inverter 2 and closing all low-side switches 3d to 3f of pulse width modulated inverter 2, or vice versa, so that energy reservoir is no longer being charged. As an alternative to this, by way of transmission controller 14 a lower transmission ratio as compared with a present transmission ratio can automatically be established, resulting in a decrease in the rotation speed of electrical machine 1 and thus in a reduction in charging power level.

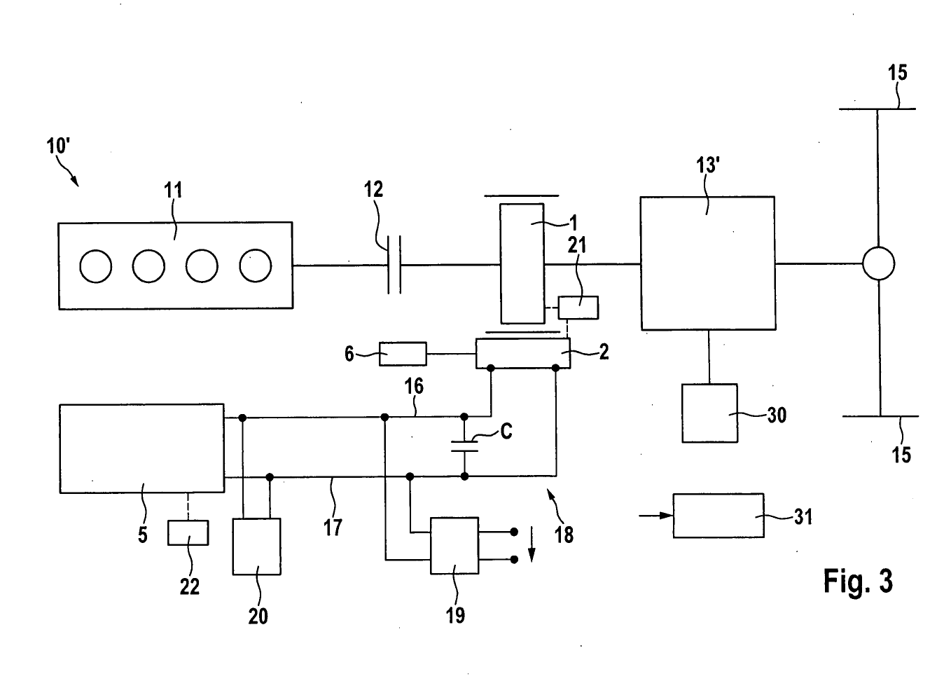

FIG. 3 schematically shows a further embodiment of a drivetrain 10′ of a hybrid vehicle (not depicted further). Drivetrain 10′ differs from drivetrain 10 depicted in FIG. 2 only in that it has, instead of automatically actuatable transmission 13, a transmission 13′ actuatable manually by way of an operating element 30, for example in the form of a gear selector lever. Because an automatic change in ratio or gear is not possible in this case, an output unit 31 is provided on which, in the event of a detected fault situation and a shortfall below the lower threshold value, a message is outputted to the driver notifying him or her of the need to select a lower gear. The message can be outputted visually in the form of a display, or also acoustically, e.g. in the form of a voice message. Information transfer among the individual detection and control components and the output unit can also occur either directly or indirectly via a higher-order control unit, which can also be integrated into one of the existing control units. Corresponding lead connections are, however, not depicted for reasons of clarity.

If the motor vehicle is equipped only with a manually actuatable transmission, in order to avoid overcharging of energy reservoir 5 it may be useful, in the context of a drivetrain 10′ according to FIG. 3 as well, to establish a lower transmission ratio as compared with a present transmission ratio, in order to decrease the rotation speed of electrical machine 1 and thereby achieve a reduction in charging power level. Because an automatic change in ratio or gear is not possible with a manually actuatable transmission 13′, however, upon exceedance of the upper threshold value for the variable characterizing the charge state of energy reservoir 5 a message can be outputted to the driver notifying him or her of the need to engage a higher gear.

What is claimed is:

1. A method for operating an electrical machine with the aid of an inverter in a motor vehicle having an automatically actuatable transmission, comprising:
generating by the electrical machine, in generator mode, electrical energy which is subsequently stored in an energy reservoir;
in a fault situation, detecting at least one variable characterizing the charge state of the energy reservoir and comparing the at least one variable with a predefined lower threshold value; and
if the at least one variable falls below the lower threshold value, i) switching the electrical machine into a freewheeling mode by opening all controllable switching elements of the inverter, and ii) establishing a higher transmission ratio than a present transmission ratio in the automatically actuatable transmission.

2. The method as recited in claim 1, further comprising:
comparing the at least one variable characterizing the charge state of the energy reservoir with a predefined upper threshold value, and if the at least one variable exceeds the upper threshold value, establishing a lower transmission ratio than the present transmission ratio in the automatically actuatable transmission.

3. A method for operating an electrical machine with the aid of an inverter in a motor vehicle having a manually actuatable transmission, comprising:
generating by the electrical machine, in generator mode, electrical energy which is subsequently stored in an energy reservoir;
in a fault situation, detecting at least one variable characterizing the charge state of the energy reservoir and comparing the at least one variable with a predefined lower threshold value; and
if the at least one variable falls below the lower threshold value, i) switching the electrical machine into a freewheeling mode by opening all controllable switching elements of the inverter, and ii) outputting a message to a driver notifying the need to engage a lower gear.

4. The method as recited in claim 3, further comprising:
comparing the at least one variable characterizing the charge state of the energy reservoir with a predefined upper threshold value, and if the at least one variable exceeds the upper threshold value, outputting a message to the driver notifying the need to engage a lower gear.

5. The method as recited in claim 1, further comprising:
comparing the at least one variable characterizing the charge state of the energy reservoir with a predefined upper threshold value, and if the at least one variable exceeds the upper threshold value, switching the electrical machine into a short circuit mode by one of i) opening all controllable switching elements of the inverter connected to a high potential and closing all controllable switching elements of the inverter connected to a low potential, or ii) closing all controllable switching elements of the inverter connected to the high potential and opening all controllable switching elements of the inverter connected to the low potential.

6. A system for controlling an electrical machine with the aid of by an inverter in a motor vehicle having an automatically actuatable transmission, the electrical machine generating, in generator mode, electrical energy which is subsequently stored in an energy reservoir, the system comprising:
a fault detection device configured to detect a fault situation;
a charge state detection device configured to detect at least one variable characterizing the charge state of the energy reservoir and compare the at least one variable with a predefined lower threshold value;
an inverter controller configured to switch the electrical machine into a freewheeling mode by opening, in the event of detection of a fault situation and the at least one variable falling below the lower threshold value, all controllable switching elements of the inverter; and
a transmission controller configured to control, in the event of detection of a fault situation and the at least one variable falling below the lower threshold value, the automatically actuatable transmission in such a way that a higher transmission ratio than a present transmission ratio is established.

7. A system for controlling an electrical machine with the aid of by an inverter in a motor vehicle having a manually actuatable transmission, the electrical machine generating, in generator mode, electrical energy which is subsequently stored in an energy reservoir, the system comprising:
a fault detection device configured to detect a fault situation;
a charge state detection device configured to detect at least one variable characterizing the charge state of the energy reservoir and compare the at least one variable with a predefined lower threshold value;
an inverter controller configured to switch the electrical machine into a freewheeling mode by opening, in the event of detection of a fault situation and the at least one variable falling below the lower threshold value, all controllable switching elements of the inverter; and
an output unit configured to output, in the event of detection of a fault situation and the at least one variable falling below the lower threshold value, a message to a driver notifying the need to engage a lower gear.
